(19) United States
(12) Patent Application Publication
(10) Pub. No.: US 2009/0168042 A1
(43) Pub. Date: Jul. 2, 2009

(54) Lithographic apparatus and device manufacturing method

(75) Inventors: Roger Johannes Maria Hubertus Kroonen, Eindhoven (NL); Sebastiaan Maria Johannes Cornelissen, Eindhoven (NL); Sjoerd Nicolaas Lambertus Donders, Vught (NL); Nicolaas Ten Kate, Almkerk (NL); Niek Jacobus Johannes Roset, Eindhoven (NL); Fransiscus Mathijs Jacobs, Asten (NL); Gerardus Arnoldus Hendricus Franciscus Janssen, Eindhoven (NL); Reinder Wietse Roos, Utrecht (NL); Mattijs Hogeland, Amsterdam (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/292,962

(22) Filed: Dec. 1, 2008

Related U.S. Application Data
(60) Provisional application No. 60/996,738, filed on Dec. 3, 2007.
(60) Provisional application No. 61/006,025, filed on Dec. 14, 2007.

(51) Int. Cl. G03B 27/60

(52) U.S. Cl. 355/73

(57) ABSTRACT

An immersion lithographic projection apparatus is disclosed. The apparatus includes a substrate table for holding a substrate, the substrate table being constructed and arranged to allow liquid to flow off the substrate and over an edge of a top surface of the substrate table, and a gutter for collecting the liquid flow under the edge. Several features for improving liquid retrieval are described.

This application claims priority and benefit under 35 U.S.C. §119(e) to U.S. Provisional Patent Application Ser. No. 60/996,738, entitled “Lithographic Apparatus and Device Manufacturing Method”, filed on Dec. 3, 2007, and to U.S. Provisional Patent Application Ser. No. 61/006,025, entitled “Lithographic Apparatus and Device Manufacturing Method”, filed on Dec. 14, 2007. The contents of those applications are incorporated herein in their entirety by reference.

### FIELD

The present invention relates to a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. The liquid may be distilled water, although other liquids can be used. An embodiment of the present invention will be described with reference to liquid. However, other fluids may be suitable, particularly a wetting fluid, an incompressible fluid and/or a fluid with higher refractive index than air, desirably a higher refractive index than water. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including liquid such as water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable are a hydrocarbon, a fluorohydrocarbon, or an aqueous solution. These are also included in an embodiment of the present invention.

However, submersing the substrate or substrate and substrate table in a bath of liquid (see, for example, U.S. Pat. No. 4,509,852, hereby incorporated in its entirety by reference) means that there is a large body of liquid that must be accelerated during a scanning exposure. This requires additional or more powerful motors and turbulence in the liquid may lead to undesirable and unpredictable effects.

One of the solutions proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504, hereby incorporated in its entirety by reference. As illustrated in FIGS. 2 and 3, liquid is supplied by at least one inlet IN onto the substrate, preferably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element.

An immersion lithography solution with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and outlets OUT can be arranged in a plate with a hole in its center and through which the projection is project. Liquid is supplied by one groove inlet IN on one side of the projection system PS and removed by a plurality of discrete outlets OUT on the other side of the projection system PL. This causes a flow of a thin film of liquid between the projection system PS and the substrate W. The choice of which combination of inlet IN and outlets OUT to use can depend on the direction of movement of the substrate W (the other combination of inlet IN and outlets OUT being inactive).

In European Patent Application Publication No. 1420300 and United States Patent Application Publication No. 2004-0136494, each of which is hereby incorporated in its entirety by reference, the idea of a twin or dual stage immersion lithography apparatus is disclosed. Such an apparatus is provided with two tables for supporting the substrate. Leveling measurements are carried out with a table at a first position, without immersion liquid. Exposure is carried out with a table at a second position, where immersion liquid is present. Alternatively, the apparatus may have only one table movable between exposure and measurement positions.

PCT patent application publication no. WO 2005/064405 discloses an all wet solution. In such a system the whole top surface of the substrate is covered in liquid. A liquid supply system provides liquid to the gap between the final element of the projection system and the substrate. That liquid is allowed to leak over the remainder of the substrate. A barrier at the edge of a substrate table prevents the liquid from escaping so that it can be removed from the top surface of the substrate table in a controlled way.

### SUMMARY

It is desirable, for example, to provide an apparatus with a system for removal of liquid from a top surface of a substrate table.

According to an aspect of the invention, there is provided an immersion lithographic projection apparatus, comprising: a substrate table for holding a substrate, the substrate table being constructed and arranged to allow a liquid flow off from the substrate and over an edge of a top surface of the substrate table, and a gutter positionable under the edge to catch the liquid, wherein the substrate table and gutter are positioned such that a portion of the edge furthest from the top surface is spaced apart from a part of the gutter by a small gap.

According to an aspect of the invention, there is provided an immersion lithographic projection apparatus, comprising: a substrate table for holding a substrate, the substrate table being constructed and arranged to allow a liquid flow off from the substrate and over an edge of a top surface of the substrate table, and a gutter positionable under the edge to catch the liquid, an opening to the gutter being covered by a liquid permeable member.

According to an aspect of the invention, there is provided an immersion lithographic projection apparatus, comprising: a substrate table for holding a substrate, the substrate table being constructed and arranged to allow a liquid flow off from the substrate and over an edge of a top surface of the substrate table, and a gutter positionable under the edge to catch the liquid, wherein the gutter comprises a plurality of vertical channels leading from outside of the gutter to inside the gutter.

According to an aspect of the invention, there is provided an immersion lithographic projection apparatus, comprising: a substrate table for holding a substrate, the substrate table being constructed and arranged to allow a liquid flow off from the substrate and over an edge of a top surface of the substrate table, and a gutter positionable under the edge to catch the liquid, the gutter having a barrier member at a bottom of the gutter so as to reduce movement relative to the gutter of liquid in the gutter due to inertia of the liquid on or during movement of the gutter.

According to an aspect of the invention, there is provided an immersion lithographic projection apparatus, comprising: a substrate table for holding a substrate, the substrate table being constructed and arranged to allow liquid to flow off the substrate and over an edge of a top surface of the substrate table, a gutter positionable under the edge to catch the liquid flow, and a shield member for containing liquid within the gutter on entering the gutter.

According to an aspect of the invention, there is provided an immersion lithographic projection apparatus, comprising: a substrate table for holding a substrate, the substrate table being, in plan, substantially rectilinear and being constructed and arranged to allow a liquid flow off from the substrate and over the four edges of the substrate table, and a gutter positioned under the edges to catch the liquid, and a liquid removal device associated with the gutter.

According to an aspect of the invention, there is provided an immersion lithographic projection apparatus, comprising: a substrate table for holding a substrate, the substrate table being constructed and arranged to allow a liquid flow off from the substrate and over an edge of a top surface of the substrate table, a gutter positionable under the edge to catch the liquid, and a low stiffness membrane between a portion of the edge furthest from the top surface and a part of the gutter.

According to an aspect of the invention, there is provided a device manufacturing method comprising projecting a patterned beam of radiation through an immersion fluid onto a substrate and allowing the immersion fluid to flow off the substrate and over an edge of a top surface of a substrate table on which the substrate is held, wherein the fluid flowing off the substrate and over the edge is caught by a gutter positioned under the edge and the fluid then permeates through a fluid permeable member covering an opening to the gutter.

According to an aspect of the invention, there is provided a device manufacturing method comprising: projecting a patterned beam of radiation through an immersion fluid onto a substrate; allowing the immersion fluid to flow off the substrate and over an edge of a top surface of a substrate table on which the substrate is held; catching the fluid flowing off the substrate and over the edge by a gutter positioned under the edge; and guiding the fluid from outside of the gutter to inside the gutter.

According to an aspect of the invention, there is provided an immersion lithographic projection apparatus, comprising: a substrate table configured to hold a substrate, the substrate table being constructed and arranged to allow a liquid flow off from the substrate and over an edge of the substrate table; and a gutter constructed and arranged to collect the liquid and to be moved independently of the substrate table.

According to an aspect of the invention, there is provided an immersion lithographic projection apparatus, comprising: a substrate table configured to hold a substrate, the substrate table being constructed and arranged to allow a liquid flow off from the substrate and over an edge of the substrate table; and a gutter constructed and arranged to collect the liquid wherein the gutter is elongate in a direction parallel to the edge.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts, in cross-section, a barrier member acting as a liquid supply and removal system which may be used in an embodiment of the present invention as a liquid supply system;

FIG. 6 illustrates, in cross-section, a liquid supply system and a liquid removal system in accordance with an embodiment of the present invention;

FIG. 7 illustrates, in plan, the substrate table and liquid removal system of FIG. 6;

FIG. 8a illustrates, in cross-section, a detail of the edge of the substrate table and the gutter;

FIG. 8b illustrates, in cross-section, a further gutter;

FIG. 9 illustrates, in cross-section, a channel;

FIG. 10 illustrates, in cross-section, an embodiment of a gutter;

FIGS. 11a-c illustrate barrier members in a bottom of a gutter;

FIGS. 12a & b illustrate one arrangement of gutter and pump;

FIG. 13 illustrates, in cross-section, an active liquid removal system for a gutter; and

FIG. 14 illustrates, in cross-section, a further embodiment of a gutter.

### DETAILED DESCRIPTION

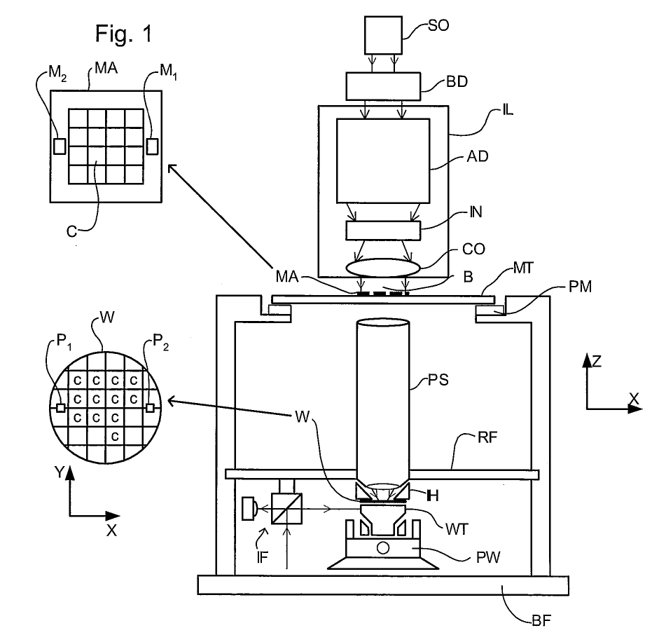

FIG. 1 schematically depicts a lithographic apparatus according to one embodiment of the invention. The apparatus comprises:
an illumination system (illuminator) IL configured to condition a radiation beam B (e.g. UV radiation or DUV radiation);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp.

The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Traditional arrangements for providing liquid between a final element of the projection system PS and the substrate can be classed into two general categories. These are the bath type arrangement in which the whole of the substrate W and optionally part of the substrate table WT is submerged in a bath of liquid and the so called localized immersion system which uses a liquid supply system in which liquid is only provided to a localized area of the substrate. In the latter category, the space filled by liquid is smaller in plan than the top surface of the substrate and the area filled with liquid remains stationary relative to the projection system PS while the substrate W moves relative to that area.

A further arrangement, to which an embodiment of the present invention is mainly directed, is the all wet solution in which the liquid is unconfined. In this arrangement the whole top surface of the substrate and all or part of the substrate table is covered in immersion liquid. This may be advantageous because then the whole top surface of the substrate is exposed to the same conditions. This has an advantage for temperature control and processing of the substrate. Also any contamination in the immersion liquid may be flushed away.

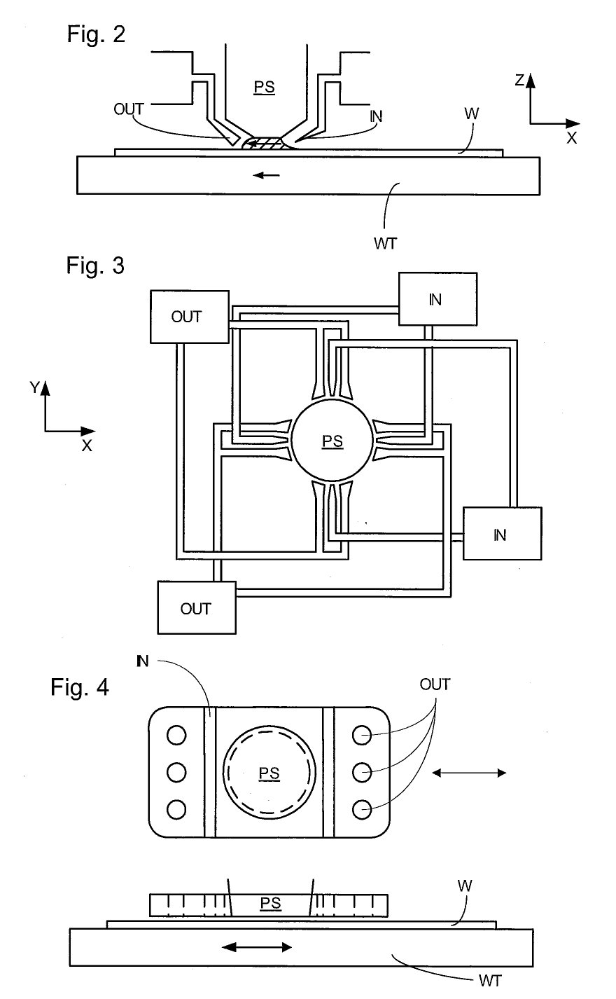

Any of the liquid supply devices of FIGS. 2-5 can also be used in such an all wet system; however, their sealing features are not present, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 were described above.

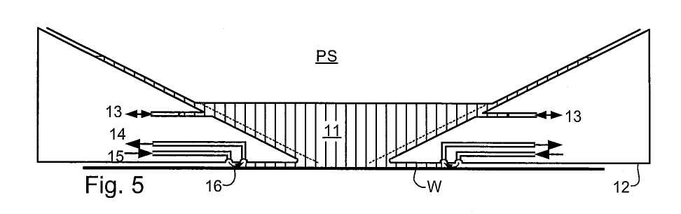

FIG. 5 schematically depicts a localized liquid supply system with a barrier member 12, which extends along at least a part of a boundary of the space between the final element of the projection system and the substrate table. The barrier member 12 is substantially stationary relative to the projection system in the XY plane though there may be some relative movement in the Z direction (in the direction of the optical axis). In an embodiment, a seal is formed between the barrier member and the surface of the substrate and may be a contactless seal such as a gas seal or fluid seal.

The barrier member 12 at least partly contains liquid in the space 11 between a final element of the projection system PL and the substrate W. A contactless seal 16 to the substrate may be formed around the image field of the projection system so that liquid is confined within the space between the substrate surface and the final element of the projection system. The space is at least partly formed by the barrier member 12 positioned below and surrounding the final element of the projection system PL. Liquid is brought into the space below the projection system and within the barrier member 12 by liquid inlet 13 and may be removed by liquid outlet 13. The barrier member 12 may extend a little above the final element of the projection system and the liquid level rises above the final element so that a buffer of liquid is provided. The barrier member 12 has an inner periphery that at the upper end, in an embodiment, closely conforms to the shape of the projection system or the final element thereof and may, e.g., be round. At the bottom, the inner periphery closely conforms to the shape of the image field, e.g., rectangular though this need not be the case.

The liquid is contained in the space 11 by a gas seal 16 which, during use, is formed between the bottom of the barrier member 12 and the surface of the substrate W. The gas seal is formed by gas, e.g. air or synthetic air but, in an embodiment, N₂ or another inert gas, provided under pressure via inlet 15 to the gap between barrier member 12 and substrate and extracted via outlet 14. The overpressure on the gas inlet 15, vacuum level on the outlet 14 and geometry of the gap are arranged so that there is a high-velocity gas flow 16 inwards that confines the liquid. The force of the gas on the liquid between the barrier member 12 and the substrate W contains the liquid in a space 11. Those inlets/outlets may be annular grooves which surround the space 11. The annular grooves may be continuous or discontinuous. The flow of gas 16 is effective to contain the liquid in the space 11. Such a system is disclosed in United States patent application publication no. US 2004-0207824.

Other arrangements are possible and, as will be clear from the description below, an embodiment of the present invention may use any type of localized liquid supply system as the liquid supply system.

One or more localized liquid supply systems seal between a part of the liquid supply system and a substrate W. Relative movement of that part of the liquid supply system and/or the substrate W may lead to breakdown of the seal and thereby leaking of liquid.

A difficulty with any of the localized area liquid supply systems is that it is difficult to contain all of the immersion liquid and to avoid leaving some behind on the substrate as the substrate moves relative to the projection system. In order to avoid liquid loss, the speed at which the substrate moves relative to the liquid supply system should be limited. This is particularly so with an immersion liquid capable of generating a high value of NA in the immersion lithography apparatus, especially a liquid other than water. Such a liquid tends to have a lower surface tension than water as well as a higher viscosity. Breakdown speed of a meniscus scales with surface tension over viscosity so that a high NA liquid may be far harder to contain. Leaving liquid behind on the substrate in only certain areas may lead to temperature variation of the substrate (for example over the surface of the substrate) due to evaporation of the immersion liquid left behind on only certain areas of the substrate and thus possibly leading to overlay error.

Also or alternatively, as the immersion liquid evaporates, it is possible that drying stains (from contamination or particles) can be left behind on the substrate W after evaporation. Also or alternatively, the liquid may diffuse into the resist on the substrate leading to inconsistency in the photochemistry of the top surface of the substrate. Although a bath type solution (i.e. where the substrate is submerged in a container of liquid) would alleviate many of these problems, substrate swap in an immersion apparatus may be particularly difficult with a bath type solution. An embodiment of the present invention addresses one or more of these or other issues as will be described below.

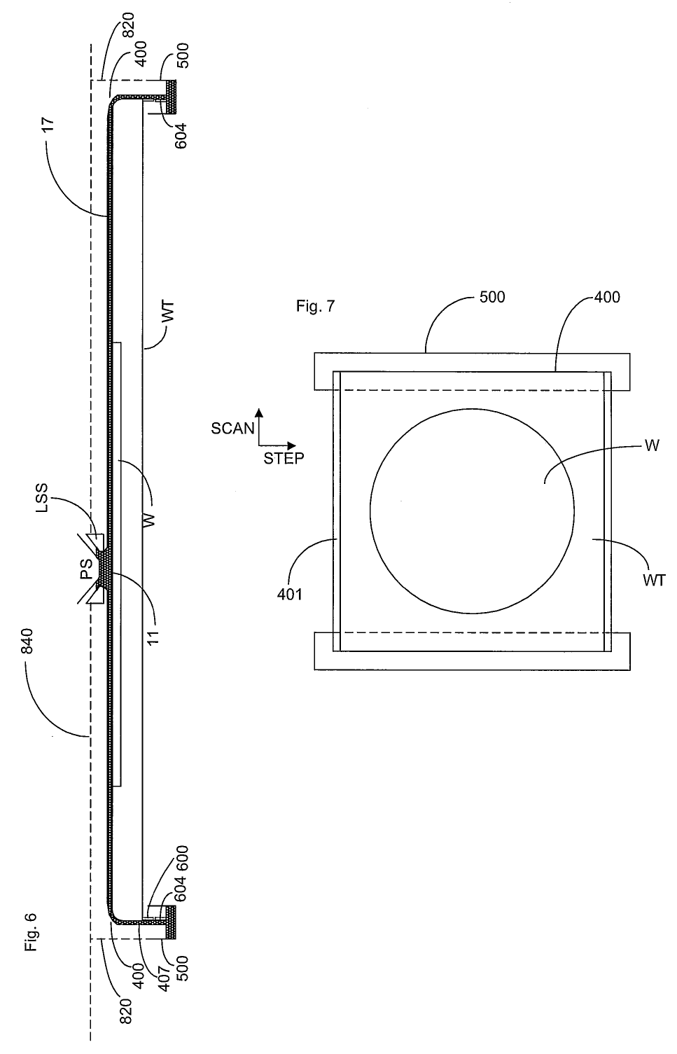

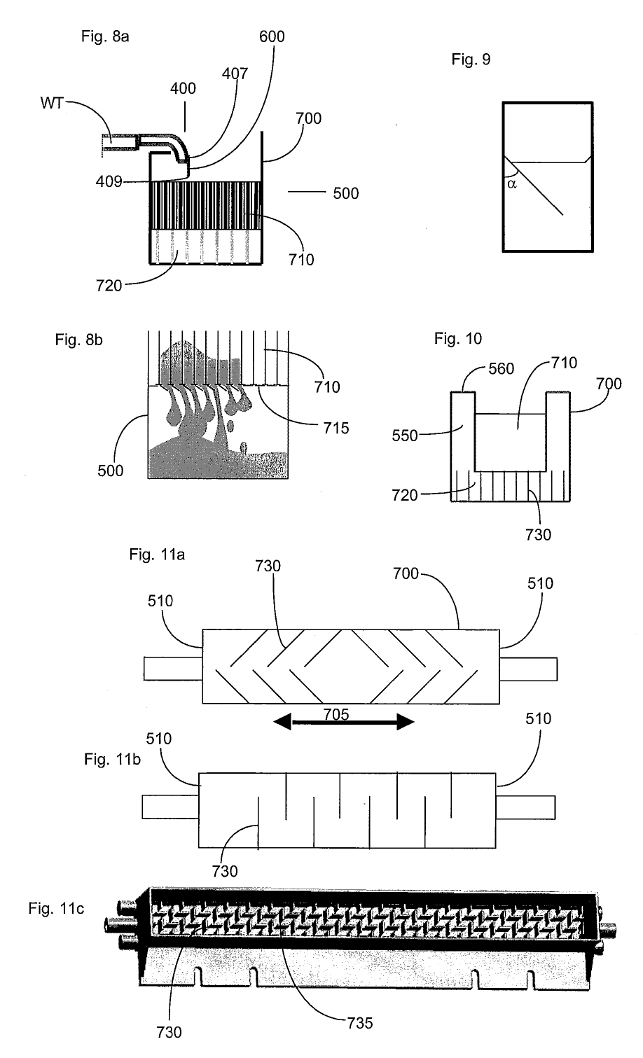

In an embodiment of the present invention, a localized liquid supply system LSS is used to provide liquid below the projection system PS above the substrate W. A flow of liquid in that area is generated. For this purpose any localized liquid supply system may be used, e.g. any one of the types shown in FIGS. 2-5, such as that illustrated in FIG. 5 or a variant thereof. However, the seal formed between the localized liquid supply system LSS and the substrate W does not need to be made to be particularly well and may in fact be entirely missing. That is, the liquid is unconfined by the liquid supply system. For example, all of the components on the bottom side of the barrier member 12 may be missing from the FIG. 5 embodiment. However, the type of seal or indeed complete absence of a seal is not critical to an embodiment of the present invention. The design is chosen such that a film or layer of liquid 17 covers substantially the whole of the top surface of the substrate W as is illustrated in FIG. 6. The top surface of the substrate table WT may be fully or partially covered in the layer of liquid 17. U.S. patent application publication no. US 2008-0073602 discloses several other embodiments which allow the whole of the top surface of the substrate W to be covered in a film of liquid 17. It will be understood that an embodiment of the present invention can be applied to all of the liquid supply systems disclosed in U.S. patent application publication no. US 2008-0073602.

In an embodiment of the present invention, liquid is allowed to drain off at least two edges 400 of the substrate table WT. The edges are edges of the top surface. The edges have an edge face 407. The edges are opposite edges of the substrate table WT. The edges are outer or outer most edges of the (top surface of the) substrate table WT. In an embodiment, the edges 400 are edges of the substrate table which are substantially perpendicular to the scan movement. This is the direction which has the longest stroke (i.e. is the long stroke direction) as well as the fastest acceleration. During the stroke the liquid is allowed to drain off along at least half or the whole length of the edge of the substrate table WT, not just at a small portion of the edge. Optionally no barrier to the flow of liquid off the substrate table (and/or barrier attached to the top surface of the substrate table WT) is provided radially outwardly of the edges over which the liquid flows.

As illustrated in FIG. 7, a barrier 401 may be provided along the edges substantially parallel to the scan direction. This barrier protrudes from the top surface of the substrate table WT to prevent liquid from falling off those edges. However, this is not necessarily the case and it can be arranged for liquid to drain off all edges of the top surface of the substrate table WT.

The liquid drains off the edges 400 and is caught by at least one gutter 500 before being removed. The gutter 500 can be mechanically dynamically decoupled from the substrate table WT or at least from the part which holds the substrate W. The gutter 500 may be attached to the long stroke positioning mechanism or may be independent of the long stroke positioning mechanism. The relative positions of the part which holds the substrate or substrate table WT and the gutter 500 may be fixed or there may be relative movement. In an embodiment, the gutter 500 has its own independent positioner, but this is not necessarily the case. A controller may be provided to move the gutter 500 such that its position is substantially constant relative to the edges 400. The gutter 500 may be moved independently of the substrate table WT. The independent movement may be in a direction perpendicular to the elongate direction of the edge.

FIG. 6 shows, in a cross-section taken in a plane parallel to the scan direction, the arrangement of the present invention. As can be seen, liquid is allowed to flow off edges 400 which are substantially perpendicular to the scan direction. The liquid drains off the edge and falls into a gutter 500 positioned under the edge. Both the edge 400 and gutter 500 of FIG. 6 are elongate extending in and out of the paper. This can be seen more clearly in FIG. 7 which is a plan view of the substrate table and gutter 500 arrangement.

As can be seen in FIG. 6, liquid is provided to an area between the projection system and the substrate W. Liquid is allowed to leak under the liquid supply system LSS over the whole of the top surface of the substrate W. Furthermore, the liquid then flows or leaks onto the top surface of the substrate table WT. Thereafter the liquid flows or leaks over the edges 400 down at least part of the face 407 of the edge (i.e. the surface substantially perpendicular to the top surface) into the gutter 500. The liquid is removed from the gutter 500 thereafter.

When the substrate table is stationary, the thickness of the liquid layer 17 covering the substrate W and top surface of the substrate table WT increases. Once a certain thickness is reached (which may be liquid property and/or geometry of substrate table dependent), liquid will flow off the edge 400 down the face 407 of the edge and into the gutter 500. Liquid falls from the bottom 409 of the edge (i.e. the portion of the edge furthest from the top surface) into the gutter 500. A problem which may occur is that individual droplets form on the bottom 409 of the edge which then detach from the bottom 409 of the edge 400 and fall into the gutter 500. This may lead to an increased flow resistance at the edge 400 because liquid is only flowing over the edge 400 at certain positions. This increased flow resistance leads to the layer of immersion liquid 17 on the substrate table WT becoming thicker. This is disadvantageous because when the substrate table WT starts to move, this thick layer of immersion liquid will, due to its inertia, pass over the edge 400 and into the gutter 500. If the thickness of the layer is too high, then the gutter 500 will quickly become full. A full gutter 500 may lead to a large load being applied to the gutter 500 as well as increasing the possibility of waves or sloshing to occur in the gutter 500. The gutter 500 may need to be made of a certain size to accommodate this excess liquid and this may be disadvantageous.

Further, during acceleration of the substrate table WT, droplets on the bottom 409 of the edge 400 may result in detachment of liquid from the substrate table WT edge 400. This can result in de-wetting of the face 407 of the edge 400 of the substrate table WT and can lead to the formation of droplets. The formation of droplets is deleterious because this may lead to splashing and thereby contamination of the immersion apparatus. Splashing has at least two consequences. It forms droplets which may contact and land on a surface of the immersion apparatus (typically the immersion system). The evaporating droplet will apply a heat load and act as a contamination source for drying stains, contaminants and contaminating particles. Secondly, it will increase the vapor pressure of the substance in the gas surrounding the immersion system (i.e. the humidity for the immersion liquid increases).

With the stroke motion of the substrate table, the flow of liquid fluctuates from a minimum quantity of liquid moving with a minimum flow rate, to a maximum quantity of liquid at peak flow. In an embodiment the variable flow is managed by controlling the movement of the substrate table WT. The movement may be managed, for example, to help ensure that the liquid flow into the gutter is smooth so that at peak flow a quantity of immersion liquid may smoothly “collapse” into the gutter 500 and be smoothly extracted. If this acceleration is not managed successfully the liquid flow may form into droplets which may splash.

In order to address the above issue it is desirable to position the gutter 500 under the edge 400 such that there is a small gap between a portion of the edge furthest from the top surface of the substrate table and part of the gutter. In an embodiment, a portion of the edge furthest from the top surface of the substrate table WT (i.e. a bottom most portion 409) is within 5 mm or 5 mm, or within 3 mm or 3 mm, from part of the gutter 500. In order for the gutter 500 to remain decoupled from the top surface of the substrate table WT, there should be at least no contact.

In an embodiment, the portion of the edge and the part of the gutter 500 which are within 5 mm of each other are close enough so that the surface tension of the liquid is enough for the liquid to be able to bridge the gap between the portion and the part without first breaking off from the portion.

Having a gap of such a small dimension allows liquid to run off the bottom 409 of the edge 400 directly onto a part of the gutter 500. Such a gap may avoid droplet formation. Adhesion due to surface tension of the liquid allows the liquid to cross from the bottom 409 of the edge 400 into the gutter 500. This improves the flow of liquid off the edge 400 into the gutter 500. One way of achieving the above dimensional limitation is to provide a downwardly extending protrusion, for example a lip 600, at the bottom of the edge 400 of the substrate table WT. The lip 600 may be a continuous rim or discontinuous, for example as one or more lips, which may be arranged in a repeating series. Having a series of lips 600 around the edge 400 enhances the de-wetting resistance. Each lip 600 has a sharp point/edge which pins the surface or meniscus of the liquid. As the surface of the liquid is smooth, surface tension of the liquid helps ensure liquid is pulled thinly across the surface of the substrate table WT, so that more of the surface of the substrate table WT is covered than normal. Spacing a series of these lips 600 along the edge 400 helps ensure that a lot more of the surface of the substrate table WT is covered. Optimizing the distance between lips 600 helps ensure that the entire surface of the substrate table WT does not de-wet. The lip 600 can extend the bottom 409 of the edge 400 of the substrate table WT below the top block or chuck of the substrate table WT. This allows space for the gutter 500 to be positioned. Particularly this allows at least one side wall 700 of the gutter 500 to extend above the bottom 409 of the edge 400 on one or both sides. This reduces the risk of contamination of the apparatus with stray immersion liquid.

The lip 600 may be angled to direct liquid into the gutter, if desired.

The part of the gutter 500 which is within 5 mm of the lip can be any sort of part or member or protrusion. For example, it could be an elongate protrusion 604 which is positioned under the lip 600. The protrusion may be continuous, such as a wall, or it may be discontinuous, such as one or more tongues which may be arranged in (a repeating) series. The lip 600 and protrusion 604 may be positioned a certain distance apart so that liquid may run down the lip 600 and onto the protrusion 604, with the liquid bridging the gap in between. As the gap is small, surface tension of the liquid keeps the flow of liquid from splashing.

Because the gutter 500 may have a different motion from the substrate table WT, the lip 600 and protrusion 604 are desirably configured to have corresponding motion so that the top end of the protrusion 604 is often, but desirably always, under the bottom end of the lip 600. Thus, the gap between the opposed ends may be minimized and splashing may thereby be minimized. In an embodiment the gutter 500 has a motion which follows the substrate table WT. This is to compensate for the linear motion of liquid as it enters the gutter (due to its linear, horizontal momentum). The liquid may substantially maintain its horizontal momentum as it leaves the gutter. However, the relative velocity of the gutter may change so the liquid may not fall absolutely vertically into the gutter. The relative velocity fluctuates, trailing the relative horizontal velocity of the table, in an oscillating manner through successive strokes. The following motion or shaping of the protrusion, desirably a tongue, may be to minimize or reduce the distance of travel across the gap into the gutter. Such a following motion may be achieved by using a controller configured to control an actuator to move the gutter 500 and thereby the protrusion 604. Alternatively or additionally, the protrusion 604 may be moved relative to the gutter. For example, such movement may be a pivoting movement such that the top surface of the protrusion 604 moves relative to the gutter. Alternatively or in addition the protrusion 604 may be shaped so that the size of the gap between the opposing ends of the lip 600 and the protrusion 604 is maintained during relative motion between the gutter 500 and the substrate table WT. Where the lip 600 is a series of protrusions (i.e. discontinuous) the protrusion 604 may have a repeating series of protrusions (e.g., tongues), where each downwardly extending protrusion 600 has a corresponding upwardly extending protrusion 604.

Thus, liquid can flow off the lip 600 onto the protrusion 604. This is illustrated in FIG. 6. Either the lip 600 or the protrusion 604 or both could be made from an elastic material. This would allow deformation in the event of a collision between the lip 600 and the protrusion 604 or some other member. This could prevent damage in the case of unintentional collision. Also, the use of a lip 600 to extend the length of the edge has an advantage that if liquid does detach from the lip, this is further from the plane in which the substrate W is held than otherwise. Thus, the effect on the substrate W (and even the substrate table WT) may be reduced by the use of such a lip 600.

The small gap may be replaced by a low stiffness membrane. The low stiffness membrane can bridge the gap and allow liquid to run over it from the lip 600 to the protrusion 604. Because the membrane has low stiffness, no or few forces are transferred between the lip 600 and the protrusion 604. The membrane may flex with the change in velocity of the substrate table, to follow the path of liquid flow once it leaves the substrate table for the gutter. This may be to compensate for the liquid maintaining its momentum, as it leaves the substrate table.

In FIG. 8a the part of the gutter 500 which is within 5 mm of the bottom of the lip is a honeycomb material 710. That is, in plan, the honeycomb material 710 presents channels which are in the shape of a hexagon. However, any structure which provides a plurality of channels leading from outside of the gutter 500 to the bottom of the gutter 500 may be used. Therefore, in plan, the shape of the channels is not necessarily hexagonal but it could also be any other shape such as circular, square, triangular, etc. In this circumstance the wall of the structure forming the channels is the part of the gutter 500 which is within 5 mm, or 5 mm, from the bottom 409 of the lip 600 of the edge.

In an embodiment, the part of the gutter within 5 mm of the lip 600 may be a permeable member, for example a permeable cloth or a perforated plate. The permeable member may have a liquidphilic outer surface and/or a liquidphobic inner surface. This encourages liquid to enter the gutter 500 and discourages liquid from leaving the gutter through the permeable member.

It is desirable to avoid liquid from creeping under the substrate table WT and making components of the substrate table WT wet. For this purpose, the inner surface of the lip 600 may be made liquidphobic. The inner surface is that surface closest to the center of the substrate table WT. If the outer surface of the lip (i.e. the right hand side as illustrated in FIG. 9) is made liquidphilic, this reduces the chance of the film breaking up on the edge 400. Indeed, the other parts of the edge 400 could also advantageously be made liquidphilic. Furthermore, if the edge of the lip 600 or bottom 409 of the edge is made sharp (for example with a radius of less than 1 mm or less than 0.5 mm or less than 0.1 mm or less than 0.01 mm), this may also reduce the chance of liquid creeping under the edge 400.

Thus, it can be seen that the lip 600 reduces the risk of de-wetting of the edge 400 of the substrate table WT. Furthermore, having a part of the gutter 500 within a small gap of the portion of the edge 400 furthest from the top surface of the substrate table WT helps ensure a smooth flow of liquid over the edge 400. It reduces the chance of detachment of the liquid layer.

As mentioned above, the gutter 500 may be at least partly filled with a structure which provides channels (which are desirably vertical or close to vertical) from outside of the gutter 500 to the bottom of the gutter 500. As can be seen from FIG. 8, the channels 710 do not lead all the way to the bottom of the gutter 500. A space 720 between the bottom of the channels 710 and the bottom of the gutter 500 is left. The space 720 allows liquid to exit the channels and then run along the gutter 500 to an extraction point at which place the liquid can exit the gutter 500.

The channels can help when the gutter 500 is very full of liquid. Such an event may occur, for example, after a period in which the substrate table WT is stationary. Then on movement of the substrate table, especially during a long stroke, particularly towards the end of the movement, a large amount of liquid will be emptied into the gutter. A lot of liquid will then flow into the gutter in a short period of time. A difficulty with the large amount of liquid is that it may slosh to and fro in the gutter 500, particularly if the gutter is moved.

By providing the vertical channels, the surface of the liquid in the gutter will be broken up into small parts thereby preventing the generation of large waves. Thus, sloshing can be prevented. Although sloshing may be prevented, substantially the speed at which liquid can flow into the gutter is barely reduced by the presence of these vertical channels.

Such a structure can be made of plastic and is therefore relatively cheap. Furthermore, the structure is light and easy to incorporate into the gutter 500. The structure may be integral with a gutter side wall. Alternatively the structure may be attached to the gutter 500 in a structural way. This can result in the remainder of the gutter 500 being made less strong (and therefore thick) because some of the necessary stiffness can be provided by the structure itself. For example, the outer wall 700 of the gutter can be made thinner.

In an embodiment, the material from which the vertical channels are made is such that the liquid has a contact angle with it of between 80 and 140 degrees. In an embodiment, the liquid has a contact angle with the material of the vertical channels of more than 90°, more than 100°, more than 110° or more than 120°. FIG. 9 illustrates the contact angle α. Such a contact angle may have the best anti-sloshing behavior. Furthermore, the maximum dimension, in plan, of the channels is desirably in the range of 2-6 mm, desirably in the range of 3-5 mm. If the maximum dimension is too small, then the liquid can stick in the channels. This may impede the flow of liquid. If the maximum dimension is too large, then liquid can slosh within the channels. The liquid may then obtain enough energy to exit the channels through the top of the channel.

It is also possible to introduce a one way valve in the bottom of each vertical channel. Passive one way valves may be used. This can prevent liquid from spraying out of the channels. Such spraying may occur due to a pressure build-up caused by acceleration (as used herein, acceleration encompasses positive acceleration or negative acceleration (deceleration)) of the gutter 500. The valves can be made from a membrane, for example. The valves could be switched by a pressure difference or mass balanced valves could be used which switch by acceleration. FIG. 8b illustrates a gutter 500 with a one way valve 715 at the bottom of each vertical channel.

Liquid is removed from the bottom of the gutter 500. However, before liquid is removed, it is possible that it may spend some time in the bottom of the gutter 500 in space 720. For example, this could occur after a movement following a time when the substrate table WT is substantially stationary. This could lead to sloshing.

As is illustrated in FIG. 10 placed in the bottom of the gutter 500 in space 720 there is at least one barrier member 730. The barrier member 730 is effective to reduce the movement relative to the gutter 500 of liquid in the space 720 due to inertia of the liquid, for example, on movement of the gutter 500. The barrier member 730 is elongate with one of its elongate directions substantially perpendicular, or at least with a component perpendicular, to the direction in which movement of liquid is intended to be prevented or reduced. The more such barrier members 730 there are, the greater the effect. However, the barrier member 730 is positioned such that there is still a path for liquid to flow from one end of the gutter 500 to the other. It will be appreciated that this is not necessary, because liquid could be removed from the gutter 500 at each longitudinal end of the gutter 500, for example. Therefore in such a case the gutter 500 could be split into two separate compartments. However, this is not illustrated in FIG. 10. The liquid can be removed from the gutter from any position along the gutter 500 and from any number of positions. An alternative would be to provide separate compartments but this would require removal of liquid from each compartment independently.

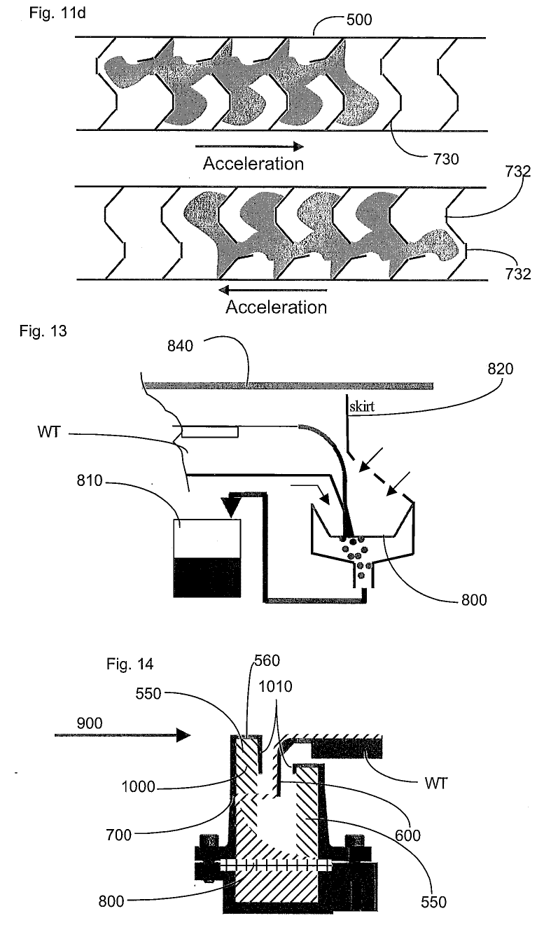

In an embodiment, the barrier member 730 is positioned and oriented to reduce movement relative to the gutter of liquid in a direction substantially parallel, or at least with a component substantially parallel, to the elongate direction of the gutter 500. FIGS. 11a-d illustrate four different, non-limiting embodiments. As illustrated in FIG. 11c, there may also be barrier members 735 oriented to reduce movement relative to the gutter of liquid in the direction substantially perpendicular, or at least with a component substantially perpendicular, to the elongate direction of the gutter. However, this is less important than reducing movement substantially parallel to the elongate direction. However, a gutter as illustrated in FIG. 11c with features for reducing movement relative to the gutter of liquid in the direction substantially perpendicular, or at least with a component substantially perpendicular, to the elongate direction of the gutter may be useful for a gutter positioned parallel to the long stroke direction. Movement is small during the short stroke so there is less need for features in the long stroke gutter to prevent sloshing of liquid during a short stroke. However, liquid may fall into a gutter positioned to collect liquid during short strokes at any time. In such a short stroke gutter it is desirable to reduce movement substantially parallel, or at least with a component substantially parallel, to the elongate direction as it is in this direction in which the long stroke occurs and liquid may be present in the short stroke gutter during a long stroke. Therefore, the barrier members 735 would reduce movement of liquid during a long stroke.

In the embodiment of FIG. 11a, the barrier members 730 are attached at an outer edge to a side wall 700 of the gutter 500. The barrier members 730 are also at an angle to the side wall 700 (i.e. not perpendicular to them). For example, the barrier members 730 may be at an angle of between 30-60° to the side wall 700 away from the elongate direction. In an embodiment, the barrier members 730 make an angle between 40 and 50° with the side wall 700. The free end of the barrier member 730 is closer to the closest end 510 of the gutter 500 than the outer end of the barrier member 730 (which is attached to the wall 700). Thus, on the left hand side of the gutter 500 as illustrated in FIG. 1 a the free ends of the barrier members 730 are closer to the left hand end of the gutter 500 than the fixed ends. Conversely, on the right hand side of the gutter 500 of FIG. 11a the free ends of the barrier members 730 are closer to the right hand side of the gutter 500 than the fixed ends. This arrangement is effective to act as a pump if the gutter 500 is moved to the left and right as illustrated by arrow 705. This works because liquid is prevented from moving relative to the gutter 500 to the right if the gutter is moved to the left by the barrier members. However, the converse is not true and the liquid is more free to move to the left of the gutter as illustrated when the gutter 500 is moved to the right. This is true for the left hand side of the gutter. Thus, on reciprocal movement left and right, liquid in the left hand side of the gutter 500 will be moved towards the left hand end 510 of the gutter (i.e. the closer end). The converse is also true. That is, liquid in the right hand side of the gutter 500 will be moved to the right hand end 510 of the gutter 500, which is the closer end. Thus, the barrier members 730 operate as a pump.

It can be that the barrier members 730 in FIG. 11a are, in plan, in a herringbone profile or in a rib profile. The pumping action achieved by the passive barrier members 730 has an advantage that it has no moving parts. An alternative way of achieving the same functionality is to use one way valves. FIG. 11d illustrates one embodiment and will be described in further detail below.

In the FIG. 11b embodiment the barrier members 730 are positioned in a similar way to those of the FIG. 11a embodiment except that they are at right angles to the side wall 700 of the gutter 500. In the FIG. 11c embodiment barrier members 730 are provided which are similar to those of FIG. 11b. Some of the barrier members 730 differ in one way in that they are not all connected to the side wall 700. Further barrier members 735 are provided which are substantially parallel to the side wall 700. These are described above.

In the FIG. 11d embodiment the barrier members 730 extend all the way across the gutter 500. Each barrier member 730 has two one way valves 732, one for flow in each direction. The barrier members 730 are ‘S’ shaped. The valves for movement through the barrier member 730 are in the concave portion of the ‘S’ shape when viewed from the side prior to passing through the valve. FIG. 11d illustrates movement of the gutter in two directions and thereby how the pumping action works.

FIG. 10 illustrates a further feature to address sloshing and the use of chambers. Liquid moving around in the bottom space 720 of the gutter 500 creates a movement of gas. This may be disadvantageous if a vertical channel of the channel structure 710 is blocked with liquid flowing down it. An increase in pressure in the bottom of the vertical channel (by moving gas) could result in liquid squirting out of the top of the channel. This difficulty may be alleviated in the FIG. 10 embodiment. The area provided with vertical channels is reduced to only a central area. The outer areas 550 of the gutter 500 are not provided with vertical channels. Instead, they are one large channel. A gas permeable or porous top 560 may be provided for the flow of gas therethrough. The porous top 560 may be repellant to liquid so that liquid does not escape through it. In an embodiment, the liquid has a contact angle of greater than 90°, greater than 100°, greater than 110° or greater than 120° to the porous top. Thus, if there is a large acceleration (for example in a direction perpendicular to the elongate direction) of the gutter 500 (which is most likely), liquid sloshing against the side wall 700 of the gutter 500 is constrained within the gutter 500 and gas displaced by such movement is unconstrained.

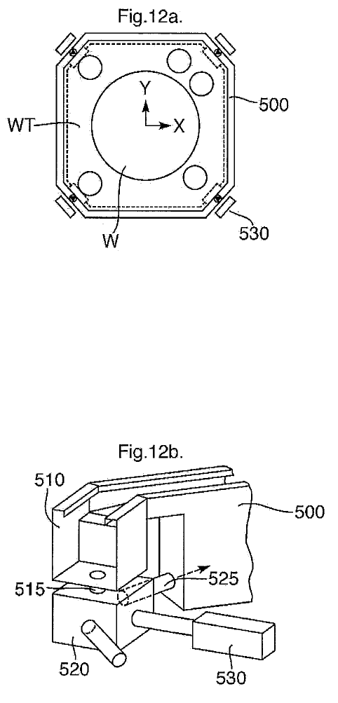

An arrangement of gutter 500 is illustrated; in plan, in FIG. 12a. In FIG. 12a, a gutter is provided around each edge of the substrate table WT. There are four gutters provided, each covering a single edge. A pump is provided at each end of each gutter 500. There are four pumps. Each pump may be connected to both gutters at which end it is situated. Thus, each gutter may be connected to two pumps. This is advantageous because it is likely that at any one time adjacent gutters will not both be full; opposite gutters are likely to be substantially full or empty at the same time. Thus, all four pumps can be effective to empty any two full gutters 500 at any one time. If one gutter receives more liquid than it could handle with a single extractor or pump, e.g. at the end of a long stroke, having access to two extraction systems or pumps enables the liquid to be extracted. This is especially the case as the two adjacent gutters are unlikely both to have a significant amount of liquid in them at the same time. The embodiment of FIGS. 12a and b is described in detail below. However, this is only an example and other arrangements may be made. Other arrangements may also include sharing of a pump between at least two gutters. The outlets do not necessarily need to be at the ends of the gutters though this is desirable. The outlets may be midway along the gutters. Irrespective of where the outlets are positioned along the length of each gutter there may be any number of outlets. The more outlets and pumps there are the quicker liquid can be extracted at the cost of increased complexity, space and/or weight.

An arrangement of how the gutters may be connected to the pump at corners of the gutters 500 is shown in FIG. 12b. Liquid leaving the substrate table at a corner flows into a sub-gutter 510 from the substrate table and/or an adjacent gutter 500. This sub-gutter is not as deep as the main gutter 500. The bottom of the sub-gutter is connected by a conduit 515 to a collection chamber 520 positioned under the sub-gutter 510. The bottoms of the adjacent gutters 500 are also connected to the collection chamber 520 by a conduit 525. The collection chamber 520 is connected to a pump 530 to extract liquid. This system is passive in that liquid flows into the gutter 500 under gravity.

A different active extraction embodiment is illustrated in FIG. 13. In this embodiment instead of vertical channels a permeable member 800 is provided. The permeable member may have the properties of the permeable member described above in relation to the gutter being within 5 mm of the edge. The permeable member covers the top opening to the gutter 500. The permeable member 800 may be a permeable cloth, for example. The permeable member may be a permeable plate. The size of through holes in the permeable member may be between 5 and 50 μm. In this way, if an under pressure is developed inside of the gutter 500, liquid on the permeable member 800 is drawn through the permeable member 800 into the gutter 500. Thus, as liquid falls onto the permeable member, it is drawn through by the under pressure and can then be extracted by pump 810.

The permeable member 800 is advantageously only permeable or only substantially permeable in the direction from outside the gutter to inside the gutter. The permeable member 800 may also only be permeable to a liquid phase (and not gas). This can be arranged by having the through hole size and magnitude of under pressure such that all through holes are blocked by liquid. A similar principle is disclosed for a single phase extractor in European patent application publication no. EP 1,628,163. The permeable member 800 may advantageously be liquidphilic on an outer surface and/or liquidphobic on an inner surface.

A skirt 820 is provided to catch any splashes. The skirt 820 may also be semi-permeable and may have the features and properties of the permeable member 800 described above. The skirt 820 allows gas to be sucked from outside of the gutter 500 when there is no liquid to be removed from the permeable member 800. The skirt can interface with a grid plate 840 to substantially enclose the environment above the substrate table WT. A similar system may be used for the embodiment illustrated in FIG. 6. This increases the vapor pressure of the immersion fluid above the substrate table. If the immersion liquid is water then there will be a humid atmosphere or an atmosphere with a high water content above the substrate table WT. The presence of a humid atmosphere reduces evaporation of liquid from the substrate table WT and thus may reduce cooling. Such vapor or liquid content of the atmosphere may be generated by splashing of the immersion fluid. The part 840 may be formed by a member other than a grid plate. The skirt 820 may be used on any embodiment.

FIG. 14 illustrates a further embodiment of gutter. FIG. 14 includes features of the embodiment of FIG. 10 as well as features of the embodiment of FIG. 13. In the FIG. 14 embodiment measures are taken to accommodate a buffer volume of liquid in the gutter on acceleration in a direction substantially perpendicular, or at least with a component substantially perpendicular, to the elongate direction of the gutter. For example, an acceleration in direction 900. As is illustrated, in this instance liquid flowing over the edge will flow down the lip 600 and then fall horizontally to the outer side wall 700 of the gutter. Gravity will act on the liquid and it will thereby fall towards the bottom of the gutter. Positioned a distance away from the bottom of the lip is a permeable membrane 800 such as that of the FIG. 13 embodiment. Below the permeable membrane the gutter is full of liquid. In order to accommodate the liquid in the outer areas 550, the outer areas are filled with a buffer material 1000. The buffer material 1000 is desirably positioned along an outer edge of the gutter. The buffer material 1000 is a porous material (for example a plastic or metal foam) which has a typical porosity of 95% and pore sizes of 0.3-3 mm. Inside of the pores the capillary pressure is higher than the pressure generated by acceleration of the gutter. Thus, the liquid is effectively contained within the buffer material 1000 and does not splash. The liquid in the buffer material 1000 seeps to the permeable membrane 800 under gravity or because liquid is sucked out from underneath the permeable membrane 800 (and thus the liquid is transported by capillary action in the buffer material). Liquid may not penetrate back through the permeable membrane 800 under typical acceleration. It will be noted that an internal downwardly extending lip 1010 is provided to the outer areas 550. The side wall 700 and lip 1010 define a buffer space between them and are capped at the top by an optionally porous top 560.

In an aspect, there is provided an immersion lithographic projection apparatus, comprising a substrate table configured to hold a substrate, the substrate table being constructed and arranged to allow a liquid flow off from the substrate and over an edge of a top surface of the substrate table, and a gutter constructed and arranged to collect the liquid under the edge, wherein the substrate table and gutter are arranged so that, at least at a point in time, a portion of the edge furthest from the top surface is spaced apart from a part of the gutter by a gap. Optionally, the gap is less than or equal to 5 mm or less than or equal to 3 mm. Optionally, the part is substantially vertically under the portion of the edge furthest from the top surface. Optionally, the portion of the edge furthest from the top surface and the part of the gutter are such that the surface tension of the liquid is enough to be able to bridge the gap between the portion and the part without breaking off from the portion. Optionally, the portion comprises a lip arranged to direct liquid into the gutter. Desirably, the lip extends downwardly. Desirably, the lip comprises a plurality of lips along the edge. Optionally, the part comprises a permeable member. Desirably, the permeable member comprises a permeable cloth. Desirably, the permeable member comprises a structure which provides a plurality of channels leading from outside of the gutter to a lower portion of the gutter. Optionally, the part comprises an upwardly extending portion. Desirably, the part comprises a plurality of tongues arranged along an elongate direction of the gutter. Optionally, the portion comprises a downwardly extending lip, the part corresponds in position to the lip and the part comprises a tongue extending upwardly from the gutter. Optionally, the gap is a small gap. Optionally, the gutter is moveable.

In an aspect, there is provided an immersion lithographic projection apparatus, comprising a substrate table configured to hold a substrate, the substrate table being constructed and arranged to allow a liquid flow off from the substrate and over an edge of a top surface of the substrate table, and a gutter constructed and arranged to collect the liquid under the edge, an opening to the gutter being covered by a liquid permeable member. Optionally, the apparatus further comprises an under pressure source configured to generate an under pressure in the gutter. Optionally, the permeable member has through holes with a diameter of between 5 and 50 μm. Optionally, the permeable member is positioned or has a protrusion positioned not in contact with but within or equal to 3 mm of a portion of the edge furthest from the top surface. Optionally, the permeable member is substantially permeable in only the direction from outside the gutter to inside the gutter. Optionally, in use, the permeable member is permeable only to a liquid phase. Optionally, the permeable member is a permeable membrane. Optionally, the permeable member is a porous member and/or is made up of multiple layers. Optionally, the permeable member is liquidphilic on an outer surface and/or liquidphobic on an inner surface. Optionally, the apparatus further comprises a porous material in the gutter. Desirably, the porous material is positioned along an outer edge of the gutter. Desirably, the gutter is moveable.

In an aspect, there is provided an immersion lithographic projection apparatus, comprising a substrate table configured to hold a substrate, the substrate table being constructed and arranged to allow a liquid flow off from the substrate and over an edge of a top surface of the substrate table, and a gutter constructed and arranged to collect the liquid under the edge, wherein the gutter comprises a plurality of vertical channels leading from outside of the gutter to inside the gutter. Optionally, the channels are formed by a honeycomb structure. Optionally, the apparatus further comprises a one way valve in each of the channels to allow liquid passage only into the gutter. Desirably, the valves are switched by a pressure difference or by acceleration of the gutter. Optionally, the liquid has a contact angle of between 80 and 140° with material forming the channels. Optionally, the maximum plan dimension of each channel is between 3.0 and 5.0 mm. Optionally, the apparatus further comprising a rib network positioned below the channels and the bottom of the gutter. Optionally, the gutter is moveable.

In an aspect, there is provided an immersion lithographic projection apparatus, comprising a substrate table configured to hold a substrate, the substrate table being constructed and arranged to allow a liquid flow off from the substrate and over an edge of a top surface of the substrate table, and a gutter constructed and arranged to collect the liquid under the edge, the gutter having a barrier member at a bottom of the gutter so as to reduce the movement relative to the gutter of liquid in the gutter due to inertia of the liquid on or during movement of the gutter. Optionally, the barrier member comprises a barrier oriented to reduce movement relative to the gutter of liquid in a direction substantially parallel to the elongate direction of the gutter. Optionally, the barrier member comprises a barrier oriented to reduce movement relative to the gutter of liquid in a direction substantially perpendicular to the elongate direction of the gutter. Optionally, the barrier member is oriented such that on repeated reciprocal movement with a component in the direction in which the gutter is elongate results in liquid in the gutter moving towards an end of the gutter. Optionally, the apparatus comprises a plurality of the barrier members arranged, in plan, in a herringbone pattern. Optionally, the barrier member is attached to the gutter at a side of the gutter and projects into the gutter at an angle with a component pointing towards the nearest end of the gutter. Optionally, the gutter is moveable.

In an aspect, there is provided an immersion lithographic projection apparatus, comprising a substrate table configured to hold a substrate, the substrate table being constructed and arranged to allow liquid to flow off the substrate and over an edge of a top surface of the substrate table, a gutter constructed and arranged to collect the liquid under the edge, and a shield member configured to contain liquid within the gutter on entering the gutter. Optionally, the shield member is configured to prevent droplets of liquid generated when the liquid enters the gutter from contaminating other parts of the apparatus. Optionally, the gutter is moveable.

In an aspect, there is provided an immersion lithographic projection apparatus, comprising a substrate table configured to hold a substrate, the substrate table being, in plan, substantially rectilinear and being constructed and arranged to allow a liquid flow off from the substrate and over the four edges of the substrate table, a gutter constructed and arranged to catch the liquid under the edges, and a liquid removal device associated with the gutter. Optionally, the apparatus comprises at least two gutters, the liquid removal device associated with at least two gutters. Optionally, the apparatus comprises at least four gutters, at least one for each edge. Optionally, the liquid removal device is connected at corners of the rectilinear shape to the gutters. Optionally, the apparatus comprises at least four liquid removal devices, at least one liquid removal device being at an end of two gutters. Optionally, the gutter is moveable.

In an aspect, there is provided an immersion lithographic projection apparatus, comprising a substrate table configured to hold a substrate, the substrate table being constructed and arranged to allow a liquid flow off from the substrate and over an edge of a top surface of the substrate table, a gutter constructed and arranged to catch the liquid under the edge, and a low stiffness membrane between a portion of the edge furthest from the top surface and a part of the gutter.

In an aspect, there is provided an immersion lithographic projection apparatus, comprising a substrate table configured to hold a substrate, the substrate table being constructed and arranged to allow a liquid flow off from the substrate and over an edge of the substrate table, and a gutter constructed and arranged to collect the liquid and to be moved independently of the substrate table. Optionally, the independent movement is in a direction perpendicular to the edge.

In an aspect, there is provided an immersion lithographic projection apparatus, comprising a substrate table configured to hold a substrate, the substrate table being constructed and arranged to allow a liquid flow off from the substrate and over an edge of the substrate table, and a gutter constructed and arranged to collect the liquid, wherein the gutter is elongate in a direction substantially parallel to the edge. Optionally, the gutter has an outlet and an active liquid extraction device configured to actively extract liquid collected by the gutter through the outlet. Optionally, the gutter is moveable independently of the substrate table in a direction substantially perpendicular to the edge. Optionally, the gutter is moveable.

In an aspect, there is provided a device manufacturing method, comprising projecting a patterned beam of radiation through an immersion fluid onto a substrate, and allowing the immersion fluid to flow off the substrate and over an edge of a top surface of a substrate table on which the substrate is held, wherein the fluid flowing off the substrate and over the edge is caught by a gutter positioned under the edge and the fluid then permeates through a fluid permeable member covering an opening to the gutter.

In an aspect, there is provided a device manufacturing method comprising projecting a patterned beam of radiation through an immersion fluid onto a substrate, allowing the immersion fluid to flow off the substrate and over an edge of a top surface of a substrate table on which the substrate is held, catching the fluid flowing off the substrate and over the edge by a gutter positioned under the edge, and guiding the fluid from outside of the gutter to inside the gutter.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the invention may take the form of one or more computer programs containing one or more sequences of machine-readable instructions describing a method as disclosed above, or one or more data storage medium (e.g. semiconductor memory, magnetic or optical disk) having such one or more computer program stored therein. The one or more different controllers referred to herein may be operable when the one or more computer programs are read by one or more computer processors located within at least one component of the lithographic apparatus. One or more processors are configured to communicate with the at least one of the controllers; thereby the controller(s) operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion fluid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. An immersion lithographic projection apparatus, comprising:
a substrate table configured to hold a substrate, the substrate table being constructed and arranged to allow a liquid flow off from the substrate and over an edge of a top surface of the substrate table; and
a gutter constructed and arranged to collect the liquid under the edge, wherein the substrate table and gutter are arranged so that, at least at a point in time, a portion of the edge furthest from the top surface is spaced apart from a part of the gutter by a gap.

2. The apparatus of claim 1, wherein the gap is less than or equal to 5 mm or less than or equal to 3 mm.

3. The apparatus of claim 1, wherein the part is substantially vertically under the portion of the edge furthest from the top surface.

4. The apparatus of claim 1, wherein the portion of the edge furthest from the top surface and the part of the gutter are such that the surface tension of the liquid is enough to be able to bridge the gap between the portion and the part without breaking off from the portion.

5. The apparatus of claim 1, wherein the portion comprises a lip arranged to direct liquid into the gutter.

6. The apparatus of claim 5, wherein the lip extends downwardly.

7. The apparatus of claim 5, wherein the lip comprises a plurality of lips along the edge.

8. The apparatus of claim 1, wherein the part comprises a permeable member.

9. The apparatus of claim 8, wherein the permeable member comprises a permeable cloth.

10. The apparatus of claim 8, wherein the permeable member comprises a structure which provides a plurality of channels leading from outside of the gutter to a lower portion of the gutter.

11. The apparatus of claim 1, wherein the part comprises an upwardly extending portion.

12. The apparatus of claim 11, wherein the part comprises a plurality of tongues arranged along an elongate direction of the gutter.

13. The apparatus of claim 1, wherein the portion comprises a downwardly extending lip, the part corresponds in position to the lip and the part comprises a tongue extending upwardly from the gutter.

14. The apparatus of claim 1, wherein the gap is a small gap.

15. The apparatus of claim 1, wherein the gutter is moveable.

16. An immersion lithographic projection apparatus, comprising:
a substrate table configured to hold a substrate, the substrate table being constructed and arranged to allow a liquid flow off from the substrate and over an edge of a top surface of the substrate table; and
a gutter constructed and arranged to collect the liquid under the edge, an opening to the gutter being covered by a liquid permeable member.

17. An immersion lithographic projection apparatus, comprising:
a substrate table configured to hold a substrate, the substrate table being constructed and arranged to allow a liquid flow off from the substrate and over an edge of a top surface of the substrate table; and
a gutter constructed and arranged to collect the liquid under the edge, wherein the gutter comprises a plurality of vertical channels leading from outside of the gutter to inside the gutter.

18. An immersion lithographic projection apparatus, comprising:
a substrate table configured to hold a substrate, the substrate table being constructed and arranged to allow a liquid flow off from the substrate and over an edge of a top surface of the substrate table; and
a gutter constructed and arranged to collect the liquid under the edge, the gutter having a barrier member at a bottom of the gutter so as to reduce the movement relative to the gutter of liquid in the gutter due to inertia of the liquid on or during movement of the gutter.

19. An immersion lithographic projection apparatus, comprising:
a substrate table configured to hold a substrate, the substrate table being constructed and arranged to allow liquid to flow off the substrate and over an edge of a top surface of the substrate table;
a gutter constructed and arranged to collect the liquid under the edge; and
a shield member configured to contain liquid within the gutter on entering the gutter.

20. An immersion lithographic projection apparatus, comprising:
a substrate table configured to hold a substrate, the substrate table being, in plan, substantially rectilinear and being constructed and arranged to allow a liquid flow off from the substrate and over the four edges of the substrate table;
a gutter constructed and arranged to catch the liquid under the edges; and
a liquid removal device associated with the gutter.

21. An immersion lithographic projection apparatus, comprising:
a substrate table configured to hold a substrate, the substrate table being constructed and arranged to allow a liquid flow off from the substrate and over an edge of a top surface of the substrate table;
a gutter constructed and arranged to catch the liquid under the edge; and
a low stiffness membrane between a portion of the edge furthest from the top surface and a part of the gutter.

22. An immersion lithographic projection apparatus, comprising:
a substrate table configured to hold a substrate, the substrate table being constructed and arranged to allow a liquid flow off from the substrate and over an edge of the substrate table; and
a gutter constructed and arranged to collect the liquid and to be moved independently of the substrate table.

23. An immersion lithographic projection apparatus, comprising:
a substrate table configured to hold a substrate, the substrate table being constructed and arranged to allow a liquid flow off from the substrate and over an edge of the substrate table; and
a gutter constructed and arranged to collect the liquid, wherein the gutter is elongate in a direction substantially parallel to the edge.

24. A device manufacturing method, comprising:
projecting a patterned beam of radiation through an immersion fluid onto a substrate; and
allowing the immersion fluid to flow off the substrate and over an edge of a top surface of a substrate table on which the substrate is held, wherein the fluid flowing off the substrate and over the edge is caught by a gutter positioned under the edge and the fluid then permeates through a fluid permeable member covering an opening to the gutter.

25. A device manufacturing method comprising:
projecting a patterned beam of radiation through an immersion fluid onto a substrate;
allowing the immersion fluid to flow off the substrate and over an edge of a top surface of a substrate table on which the substrate is held;
catching the fluid flowing off the substrate and over the edge by a gutter positioned under the edge; and
guiding the fluid from outside of the gutter to inside the gutter.
